(19) United States
(12) Patent Application Publication
(10) Pub. No.: US 2009/0294001 A1
(43) Pub. Date: Dec. 3, 2009

(54) VEHICLE TIRES HAVING COATED TREAD

(75) Inventors: Christian Weber, Garbsen (DE); Lutz Ackermann, Müden (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hanover (DE)

(21) Appl. No.: 12/505,707

(22) Filed: Jul. 20, 2009

Related U.S. Application Data
(63) Continuation of application No. PCT/EP2007/062779, filed on Nov. 26, 2007.

(30) Foreign Application Priority Data
Jan. 20, 2007 (DE) 10 2007 003 062.4

(51) Int. Cl. B60C 1/00

(52) U.S. Cl. 152/209.5

(57) ABSTRACT

Vehicle tires, particularly for commercial vehicles, contain a profiled tread, which is broken down into profiled ribs or block rows by a number of peripheral grooves and is made of a first rubber mixture. A groove base of the peripheral grooves is made of a second rubber mixture, and the modulus of elasticity of the second rubber mixture is less than the modulus of elasticity of the first rubber mixture of the main part of the tread. In particular, the second rubber mixture has a modulus M 100%, which is 5% to 20% less than the modulus M 100% of the first rubber mixture of the main part of the tread. The two rubber mixtures are based on a substantially identical or comparable polymer system.

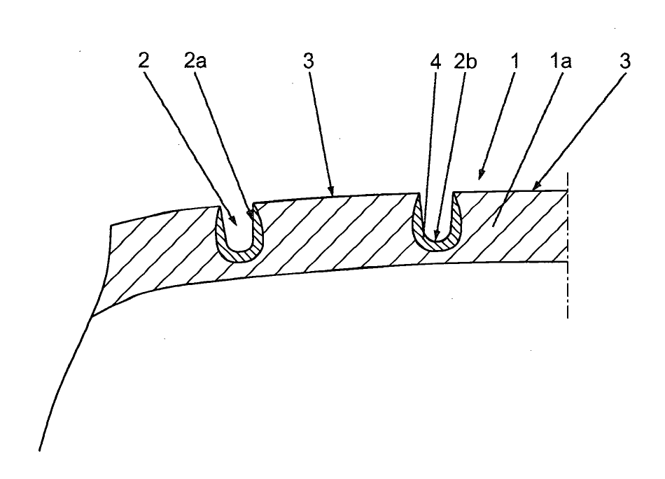

### CROSS-REFERENCE TO RELATED APPLICATION

This is a continuing application, under 35 U.S.C. § 120, of copending international application No. PCT/EP2007/062779, filed Nov. 26, 2007, which designated the United States; this application also claims the priority, under 35 U.S.C. § 119, of German patent application No. DE 10 2007 003 062.4, filed Jan. 20, 2007; the prior applications are herewith incorporated by reference in their entirety.

### BACKGROUND OF THE INVENTION

### Field of the Invention

The invention relates to a pneumatic vehicle tire, especially for commercial vehicles. The tire has a profiled tread which is divided by a number of circumferential grooves into profile ribs or block series and which has a main part composed of a first rubber mixture and rubber layers composed of a second rubber mixture which line at least the groove base of the circumferential grooves. The modulus of elasticity of the rubber mixture of the rubber layers is less than the modulus of elasticity of the rubber mixture of the main part of the tread.

Such a pneumatic vehicle tire is known, for example, from international patent disclosure WO 00/53437 A, corresponding to U.S. Pat. No. 6,213,181. The rubber layers which line the circumferential grooves have a modulus of elasticity at 10% elongation (according to ASTM standard test) which is between 40% and 80% of the modulus of elasticity of the main part of the tread determined in the same way. The rubber layers which line the circumferential grooves extend up to the tread periphery and are intended to contribute to homogenization of the stress distribution in a transverse direction of the blocks or ribs and substantial prevention of stress concentrations on the ribs or block edges running in a circumferential direction. Published, European patent application EP 1 241 026 A, corresponding to U.S. patent publication No. 2006/0157177 A1, proposes introducing, in the immediate vicinity of the groove base of the circumferential groove, in each case a rubber mixture which has a particularly high elongation at break. This is intended to suppress the formation of tears in the region of the groove base of the circumferential groove or prevent propagation of cuts which have already formed.

German patent DE 1 194 721 also addresses the prevention of tear formation in the circumferential grooves of a tread. The circumferential grooves are lined with a rubber layer with a high tear and tear propagation resistance, which is configured such that its thickness decreases from the channel base toward the channel flanks.

In order to prevent the formation of tears on the groove base of the circumferential grooves, it is advisable to line only the groove base with a rubber layer which has no or barely any tendency to tear. In practice, however, it has been found to be difficult to impossible to provide the rubber layer only in the groove base; parts of the mixture introduced reach at least into the groove flanks, usually even up to the tread surface. As a result, this mixture is present in a region of the tread which is subject to abrasion.

### SUMMARY OF THE INVENTION

It is accordingly an object of the invention to provide vehicle tires having a coated tread which overcomes the above-mentioned disadvantages of the prior art devices of this general type. More specifically, it is an object of the invention to ensure, in a tire, that the rubber layers at least substantially prevent the formation of tears on the groove base of the circumferential grooves and exhibit an abrasion performance equating to that of the rubber mixture of the main part of the tread.

With the foregoing and other objects in view there is provided, in accordance with the invention, a pneumatic vehicle tire. The tire contains a profiled tread having a number of circumferential grooves each with a groove base. The circumferential grooves divide the profiled tread into profile ribs or block series. The profiled tread has a main part composed of a first rubber mixture and rubber layers composed of a second rubber mixture lining at least the groove base of the circumferential grooves. A modulus of elasticity of the second rubber mixture of the rubber layers are less than a modulus of elasticity of the first rubber mixture of the main part of the profiled tread. The second rubber mixture of the rubber layers has a modulus M 100% which is 5% to 20% lower than the modulus M 100% of the first rubber mixture of the main part of said profiled tread. The first and second rubber mixtures are based on a substantially corresponding or comparable polymer system.

The stated object is achieved in accordance with the invention by virtue of the rubber mixture of the rubber layers having a modulus M 100% which is 5% to 20% lower than the modulus M 100% of the rubber mixture of the main part of the tread, and by virtue of the two rubber mixtures being based on a substantially corresponding or comparable polymer system. The two rubber mixtures preferably also have corresponding or comparable filler systems.

It has been found that even a difference of 5% in the modulus M 100% is sufficient to lower the dynamic fatigue of the rubber layers in the circumferential grooves to such an extent that the number of tears on the groove base over the lifetime of the tire is reduced significantly. The only slightly lower modulus of the rubber layers, together with the measure of using polymer systems and if appropriate also filler systems whose properties are similar but substantially correspond for the rubber mixture and the rubber mixture of the main component of the tread, ensures that the abrasion of the tread is homogeneous even where the different rubber mixtures come into contact with the underlying surface.

In a preferred embodiment of the invention, the modulus M 100% of the rubber mixture of the rubber layers is 10% to 15% lower than that of the rubber mixture of the main part of the tread. Specifically in this configuration, a particularly significant reduction in the number of tears on the groove base is found, while the abrasion performances of the two rubber mixtures are still on a level.

The rubber mixture for the rubber layers and the rubber mixture for the main part are based especially on one or more of the rubbers SBR, BR, NR/IR, the proportions of these rubbers in one rubber mixture differing from the proportions of these rubbers in the other rubber mixture by not more than 6 phr per rubber used.

The proportion of carbon black and/or silica in the rubber mixture of the rubber layers differs from the proportion of carbon black and/or silica in the rubber mixture of the main part likewise by not more than 6 phr per filler used. In the case of differences in these orders of magnitude, the polymer systems and filler systems are sufficiently similar that the mixtures barely differ, if at all, with regard to their abrasion performance. Alternatively or additionally, the dibutyl phthalate (DBP) number or iodine absorption number of the carbon black and/or silica fillers in the rubber mixture of the rubber layers may differ from those in the rubber mixture of the main part by not more than 15%.

The rubber layers are further configured such that they have a maximum thickness at the groove base of 4 mm, and a maximum thickness at the groove flanks of 6 mm.

Other features which are considered as characteristic for the invention are set forth in the appended claims.

Although the invention is illustrated and described herein as embodied in vehicle tires having a coated tread, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, cross-sectional view through a tread of a pneumatic tire of an embodiment according to the invention.

### DETAILED DESCRIPTION OF THE INVENTION

Referring now to the single FIGURE of the drawing in detail thereof, there is shown a cross sectional view through a tread 1 of a pneumatic vehicle tire, which is a truck tire in radial design and may otherwise be of conventional construction, and more particularly has an airtight inner layer, a radial carcass which is conducted around bead cores and bead regions, a multilayer breaker belt and side walls. The radially outermost belt ply is present radially within the tread 1 shown. The tread 1 is divided by broad circumferential grooves 2, which may be configured, for example, as straight or zig-zag grooves running in a circumferential direction, into profile ribs or block series 3. Profile ribs 3 are typically structured by indentations, if appropriate by channels which end in the manner of a blind groove; block series consist of a row of successive profile blocks which are separated from one another in circumferential direction by transverse channels.

The circumferential grooves 2 are delimited by two side flanks 2a opposite one another and a groove base 2b which connects them and is rounded in an approximately U shape in the embodiment shown, the transitions between the groove base 2b and the flanks 2a being fluid. A separate rubber layer 4 forms or surrounds at least the groove base 2b. In the embodiment shown, the rubber layer 4 reaches in the radial direction at least over part of the extent of the side flanks 2b. The rubber layers 4 have, at the groove base 2b, a thickness between 2 mm and 4 mm, and at the groove flanks 2a of up to 6 mm, and are either of constant thickness or essentially constant thickness over their extent or are configured such that their thickness becomes lower along the side flanks 2a in the direction toward the upper side of the tread. It is also possible to configure and to arrange the rubber mixtures 4 such that they reach up to the tread periphery.

The tread 1 therefore is formed of a main part 1a composed of a first rubber mixture and of rubber layers 4 of a second rubber mixture which line the circumferential grooves 2 at least in the region of the groove base 2b. The rubber mixture for the rubber layers 4 is configured such that its modulus M 100% (at 100% extension, determined to DIN 53504) is between 5% and 20% lower than the modulus M 100% of the rubber mixture of the main part 1a of the tread 1. The difference is especially 10% to 15%. The rubber mixture of the rubber layers 4 therefore has a lower dynamic fatigue compared to the rubber mixture for the main part 1a. This suppresses the occurrence of tears at the profile base in the circumferential grooves 2 or at least shifts it to a substantially later time or significantly reduces the intensity in which it occurs.

Since it is very difficult to provide or to mount the rubber layers 4 only in the region of the groove base 2b of the circumferential grooves 2, it is in practice unavoidable that the rubber layers 4 also cover the side flanks 2a. The rubber mixture of the rubber layers 4 thus enters a region with which the tire comes into contact with the underlying surface while the tread is driven. The mixture for the rubber layers 4 and the rubber mixture for the main part 1a of the tread 1 should therefore ideally not differ, or differ only inappreciably, in terms of their abrasion behavior, since inhomogeneous abrasion is otherwise unavoidable, which would ultimately lead to a reduced service life of the tire. In order that the rubber mixtures possess very similar abrasion behavior, substantially corresponding polymer systems are used for the rubber mixture of the rubber layers 4 and for the rubber mixture of the main part 1a of the tread 1. The proportions of fillers and the types of fillers used should also differ as little as possible. The lower modulus of the mixture for the rubber layers 4 is therefore preferably achieved by virtue of this mixture being less crosslinked through a reduction in the amount of sulfur and/or accelerant than the rubber mixture of the main part 1a. In addition, the rubber mixture for the rubber layers 4 may contain a carbon black of lower activity and/or a somewhat lower proportion of fillers (carbon black and/or silica) than the mixture of the main part 1a of the tread 1. Table 1 which follows shows, by way of example, a rubber mixture for the main part 1a and a rubber mixture for the rubber layers 4.

TABLE 1

| | Rubber mixture | Rubber mixture |
|---|---|---|
| | Main part 1a | Rubber layers 4 |
| Rubber [phr] | 100 | 100 |
| Filler [phr] | 50 | 50 |
| Sulfur [phr] | 1.2 | 1.0 |
| Accelerant [phr] | 0.9 | 0.75 |

The mixtures otherwise contain the customary further additives such as zinc oxide and processing aids in the amounts customary in each case.

Both the rubber mixture for the rubber layers 4 and the rubber mixture for the main part 1a of the tread 1 preferably contain one of the rubbers SBR, BR or NR/IR. As already mentioned, the polymer systems for these two rubber mixtures correspond substantially. The proportions of these rubbers in one rubber mixture therefore differ from the proportions of these rubbers in the other rubber mixture by at most 6 phr per rubber. For the proportions of the carbon black and/or silica fillers too, the proportion of carbon black and/or silica in the rubber mixture of the rubber layers 4 differs from the proportion of carbon black and/or silica in the rubber mixture of the main part 1a by at most 6 phr for each filler. Alternatively or additionally, the DBP numbers (dibutyl phthalate numbers) or the iodine absorption numbers of these fillers in the rubber layers may also differ by not more than 15%.

1. A pneumatic vehicle tire, comprising:
a profiled tread having a number of circumferential grooves each with a groove base formed therein, said circumferential grooves dividing said profiled tread into one of profile ribs and block series, said profiled tread having a main part composed of a first rubber mixture and rubber layers composed of a second rubber mixture lining at least said groove base of said circumferential grooves, a modulus of elasticity of said second rubber mixture of said rubber layers being less than a modulus of elasticity of said first rubber mixture of said main part of said profiled tread, said second rubber mixture of said rubber layers has a modulus M 100% which is 5% to 20% lower than the modulus M 100% of said first rubber mixture of said main part of said profiled tread, and said first and second rubber mixtures are based on a substantially corresponding or comparable polymer system.

2. The pneumatic vehicle tire according to claim 1, wherein said second rubber mixture of said rubber layers and said first rubber mixture of said main part have a substantially corresponding or comparable filler system.

3. The pneumatic vehicle tire according to claim 1, wherein the modulus M 100% of said second rubber mixture of said rubber layers is 10 to 15% lower than that of said first rubber mixture of said main part of said profiled tread.

4. The pneumatic vehicle tire according to claim 1, wherein said second rubber mixture for said rubber layers and said first rubber mixture for said main part are based on at least one rubber selected from the group consisting of SBR, BR, NR/IR, and proportions of said rubbers in one rubber mixture differ from proportions of said rubbers in the other rubber mixture by at most 6 phr per rubber.

5. The pneumatic vehicle tire according to claim 1, wherein said second rubber mixture of said rubber layers and said first rubber mixture of said main part contain at least one of carbon black and silica as fillers, a proportion of said carbon black and said silica in said second rubber mixture of said rubber layers differing from a proportion of said carbon black and said silica in said rubber mixture of said main part by at most 6 phr per filler.

6. The pneumatic vehicle tire according to claim 1, wherein said second rubber mixture of said rubber layers and said first rubber mixture of said main part contain at least one of carbon black and silica as a filler, a dibutyl phthalate (DBP) number or an iodine absorption number of said fillers in said second rubber mixture of said rubber layers differing from those in said first rubber mixture of said main part by not more than 15%.

7. The pneumatic vehicle tire according to claim 1, wherein said rubber layers have a maximum thickness at said groove base of 4 mm.

8. The pneumatic vehicle tire according to claim 1, wherein said circumferential grooves have groove flanks and said rubber layers have a maximum thickness on said groove flanks of 6 mm.

9. The pneumatic vehicle tire according to claim 1, wherein the pneumatic vehicle tire is for commercial vehicles.
